(19) United States
(12) Patent Application Publication
(10) Pub. No.: US 2017/0064046 A1
(43) Pub. Date: Mar. 2, 2017

(54) COMMUNICATION DEVICE, COMMUNICATION METHOD, AND COMPUTER PROGRAM PRODUCT

(71) Applicant: Kabushiki Kaisha Toshiba, Minato-ku (JP)

(72) Inventor: Kensaku YAMAGUCHI, Kawasaki (JP)

(73) Assignee: Kabushiki Kaisha Toshiba, Minato-ku (JP)

(21) Appl. No.: 15/245,595

(22) Filed: Aug. 24, 2016

(30) Foreign Application Priority Data
Aug. 28, 2015 (JP) 2015-169775

(51) Int. Cl. H04L 29/06

(52) U.S. Cl. CPC H04L 69/163; H04L 69/166

(57) ABSTRACT

According to an embodiment, a communication device includes a receiving unit, an extraction unit, an integration unit, and a processing unit. The receiving unit receives an aggregated frame in which a plurality of subframes are aggregated. The extraction unit extracts each of the subframes from the aggregated frame received by the receiving unit. The integration unit integrates, among the subframes extracted by the extraction unit, subframes corresponding to the same Transmission Control Protocol (TCP) connection. The processing unit performs protocol processing on the subframes integrated by the integration unit.

### CROSS-REFERENCE TO RELATED APPLICATIONS

This application is based upon and claims the benefit of priority from Japanese Patent Application No. 2015-169875, filed on Aug. 28, 2015; the entire contents of which are incorporated herein by reference.

### FIELD

Embodiments described herein relate generally to a communication device, a communication method, and a computer program product.

### BACKGROUND

According to wireless local area network (LAN) standards compliant with IEEE 802.11, hierarchical layers higher than a physical layer include a data link layer (including a media access control (MAC) sublayer and a logical link control (LLC) sublayer), a network layer (to which the Internet Protocol (IP) is applied), a transport layer (to which the Transmission Control Protocol (TCP) is applied), and an application layer. As a communication technology based on such hierarchical processing, a technology has been disclosed that allows a plurality of data link layer frames containing user data to be aggregated into one physical layer frame, thus increasing the amount of user data to be transmitted in the physical layer frame.

Although the frames are aggregated in the physical layer, the payloads of the frames are not aggregated in layers higher than the data link layer and thus are treated as independent, entities. For example, if the payload of multiple frames at the data link layer contain payloads of IP packets at the network layer, protocol processing of the IP (hereinafter, called IP processing) needs to be separately performed packet by packet even when the frames are aggregated to be transmitted as one physical layer frame. Specifically, in the transmission operation, the packets are subjected to the IP processing, stored in the frames at to data link layer, and then are aggregated into the physical layer frame. In a receiving operation, the physical layer frame is divided into a plurality of frames at the data link layer, and then the packets contained in each of the frames at the data link layer are subjected to the IP processing.

In addition, if the payload of the packets is TCP segments, protocol processing of the TCP (hereinafter, called TCP processing) is performed before the IP processing in the transmission operation, and the TCP processing is performed after the IP processing in the receiving operation. In particular, if a plurality of packets are such that different TCP segments on the same TCP connection are handled in the receiving operation, pieces of data of the TCP segments (segment data) are concatenatedas a result of the TCP processing, and are transferred as a sequential data stream to, for example, the application layer. Thus, even when the packets are eventually put together into a sequential data stream, the IP processing and the TCP processing need to be performed packet by packet. Moreover, in the receiving operation, identification of the TCP connection as the TCP processing is performed using identification information constituted by four values, that is, a source IP address and a destination IP address included in an IP header, and a source port and a destination port included in a TCP header. In the identification of the TCP connection, the identification information described above is used to perform processing to search for a transmission control block (TCB) that holds internal variables corresponding to the TCP connection. The identification of the TCP connection also needs to be performed packet by packet.

### BRIEF DESCRIPTION OF THE DRAWINGS

FIG. 1 is a diagram illustrating an example of an overall configuration of a communication system of a first embodiment;

FIG. 2 is a diagram illustrating a hardware configuration of a communication terminal of the first embodiment;

FIGS. 3A and 3B are diagrams illustrating structures of a physical layer frame and a subframe;

FIG. 4 is a diagram illustrating a structure of a MAC header;

FIG. 5 is a diagram illustrating a structure of an LLC header;

FIG. 6 is a diagram illustrating a structure of an IP header;

FIG. 7 is a diagram illustrating a structure of a TCP header;

FIG. 8 is a diagram illustrating a structure of a flag field of the TCP header;

FIG. 9 is a functional block configuration diagram of the communication terminal of the first embodiment;

FIG. 10 is a diagram illustrating an example of a structure of a subframe information table;

FIG. 11 is a diagram explaining an operation of connecting subframes;

FIG. 12 is a diagram illustrating an example of a structure of a ICE information table;

FIG. 13 is a flowchart of received data processing of the first embodiment;

FIG. 14 is a functional block configuration diagram of a communication terminal of a second embodiment;

FIGS. 15A and 15B are diagrams explaining operations of rearranging the subframes;

FIGS. 16A and 16B are diagrams explaining operations of adding identification information to the subframes; and

FIG. 17 is a flowchart of received data processing of the second embodiment.

### DETAILED DESCRIPTION

According to an embodiment, a communication device includes a receiving unit, an extraction unit, an integration unit, and a processing unit. The receiving unit receives an aggregated frame in which a plurality of subframes are aggregated. The extraction unit extracts each of the subframes from the aggregated frame received by the receiving unit. The integration unit integrates, among the subframes extracted by the extraction unit, subframes corresponding to the same Transmission Control Protocol (TCP) connection. The processing unit performs protocol processing on the subframes integrated by the integration unit.

The following describes in detail a communication device, a communication method, and a computer program according to embodiments of the present invention with reference to the accompanying drawings. The drawings are only schematic, so that specific configurations thereof should be determined in consideration of the following description.

### First Embodiment

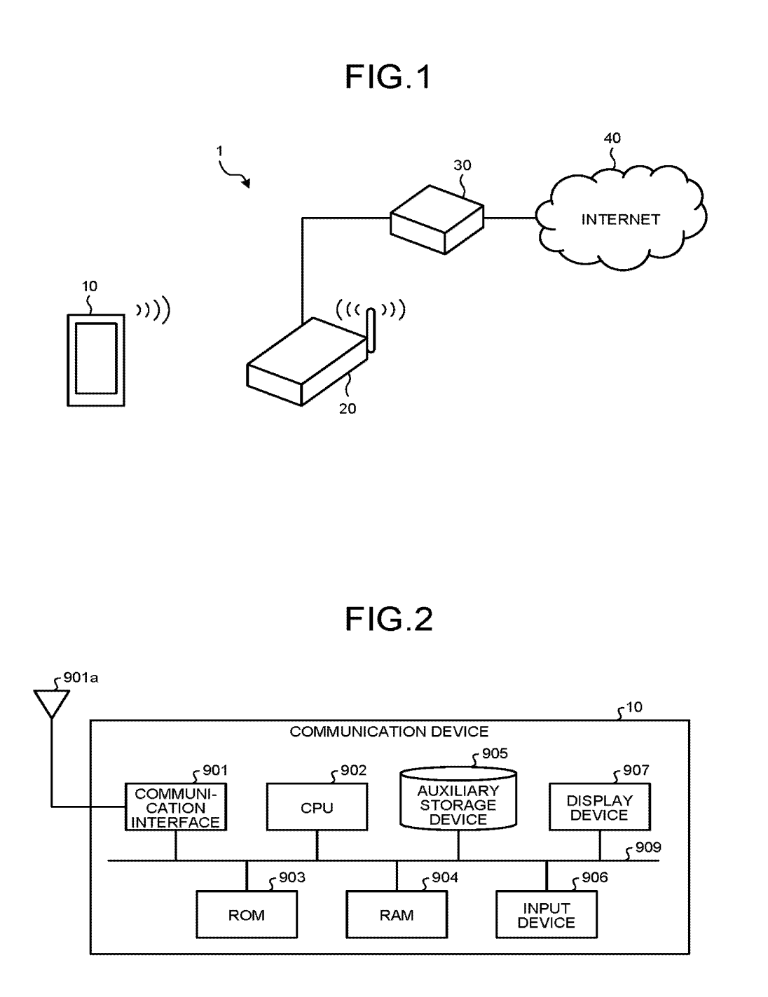

FIG. 1 is a diagram illustrating an example of an overall configuration of a communication system of a first embodiment. The overall configuration of this communication system 1 will be described with reference to FIG. 1.

As illustrated in FIG. 1, the communication system 1 according to the first embodiment includes a communication terminal 10, an access point 20, and a router 30.

The communication terminal 10 is a terminal device for transmitting and receiving data to and from the access point 20 through wireless communication. The communication terminal 10 is, for example, a tablet computer or a personal computer (PC) having a wireless communication interface. The communication terminal 10 performs the wireless communication according to a wireless LAN standard, such as Wi-Fi (registered trademark).

The access point 20 is a facility or a device that, for example, receives a connection request from the communication terminal 10, and serves as an intermediate for communication with a network, such as the Internet, at an end of a communication network.

The router 30 is a telecommunication device that relays communication data between two or more networks, on the communication network. In the example of the communication system 1 illustrated in FIG. 1, the router 30 performs the relay between two networks, that is, the network of the communication terminal 10 and the access point 20 established through the wireless LAN and the Internet 40.

The configuration of the communication system 1 illustrated in FIG. 1 is merely an example. The embodiments are not limited to this configuration. For example, although FIG. 1 illustrates only one communication terminal 10, the configuration may be such that a plurality of such communication terminals 10 wirelessly communicate with the access point 20.

FIG. 2 is a diagram illustrating an example of a hardware configuration of the communication terminal of the first embodiment. The hardware configuration of the communication terminal 10 according to the present embodiment will be described with reference to FIG. 2.

As illustrated in FIG. 2, the communication terminal 10 includes a communication interface 901, an antenna 901a, a central processing unit (CPU) 902, a read-only memory (ROM) 903, a random access memory (RAM) 904, an auxiliary storage device 905, an input device 906, and a display device 907.

The communication interface 901 is an interface for wirelessly communicating with the access point 20 via the antenna 901a.

The CPU 902 is a device that controls the overall operation of the communication terminal 10. The ROM 903 is a nonvolatile storage device that stores programs, such as firmware, for the communication terminal 10. The RAM 904 is a volatile storage device used as work area of the CPU 902.

The auxiliary storage device 905 is a storage device, such as a hard disk drive (HDD) or a solid state drive (SSD), that stores an operating system (OS), application programs, and various types of data.

The input device 906 is an input device or devices, such as a mouse, a keyboard and/or a touchscreen panel, for operations, such as entering characters and numbers, selecting various instructions, and moving a cursor. The display device 907 is a display device, such as a touchscreen panel, a liquid-crystal display (LCD), a plasma display, or an organic electroluminescence display, that displays various types of information, such as a cursor, menus, windows, characters and images.

The communication interface 901, the CPU 902, the ROM 903, the RAM 904, the auxiliary storage device 905, the input device 906, and the display device 907 are connected so as to be capable of communicating with one another through a bus 909 including, for example, an address bus and a data bus.

The above-mentioned programs for the communication terminal 10 may be distributed by being recorded as a file in an installable or executable format in a computer-readable recording medium, such as a compact disc read-only memory (CD-ROM), a compact disc recordable (CD-R), a digital versatile disc (DVD), or a Blu-ray Disc.

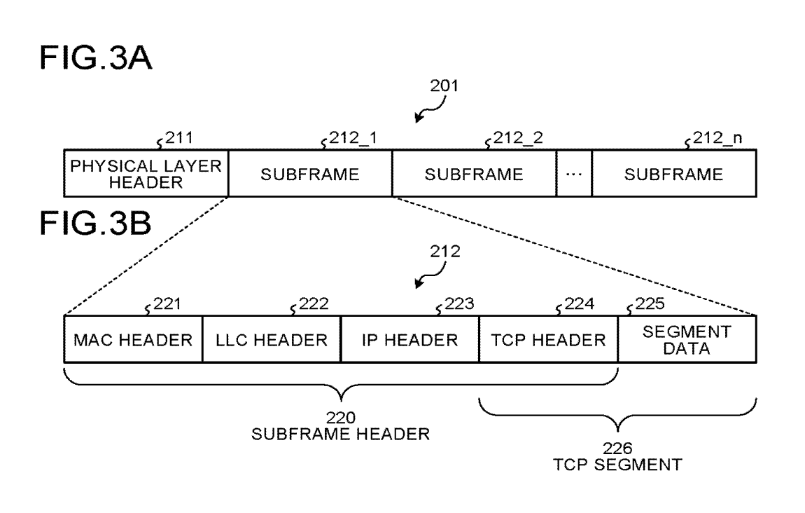

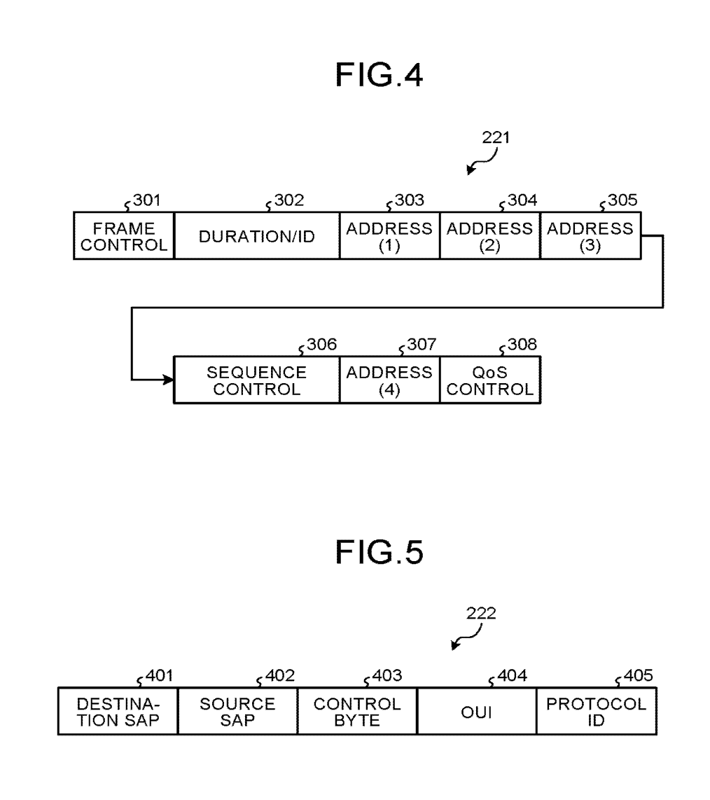

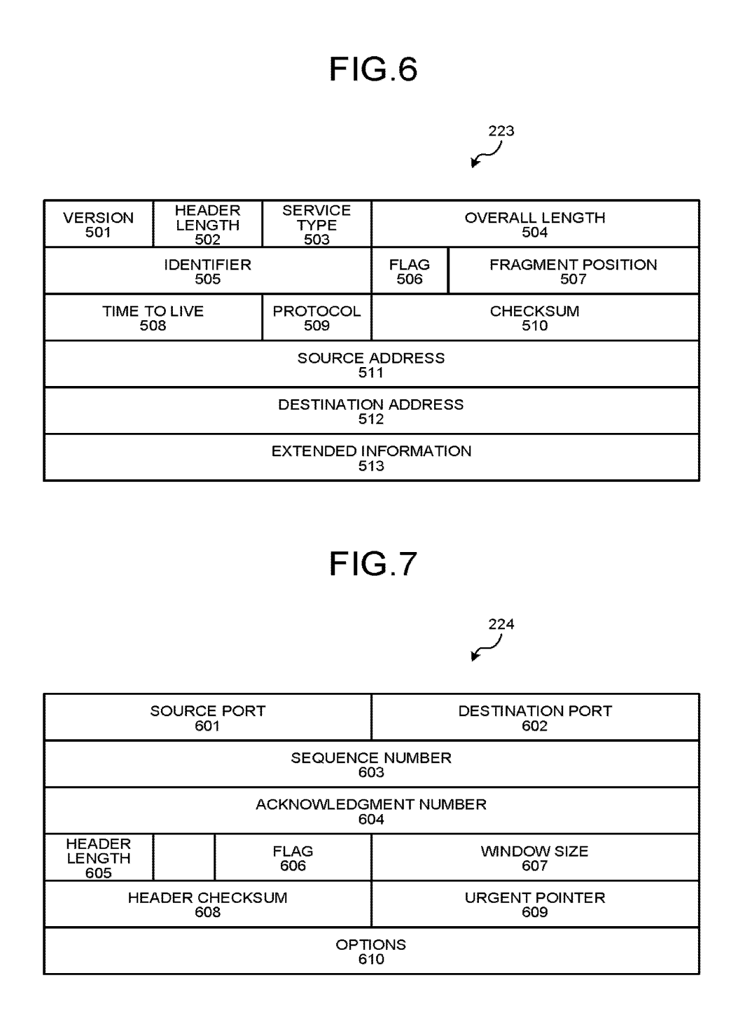

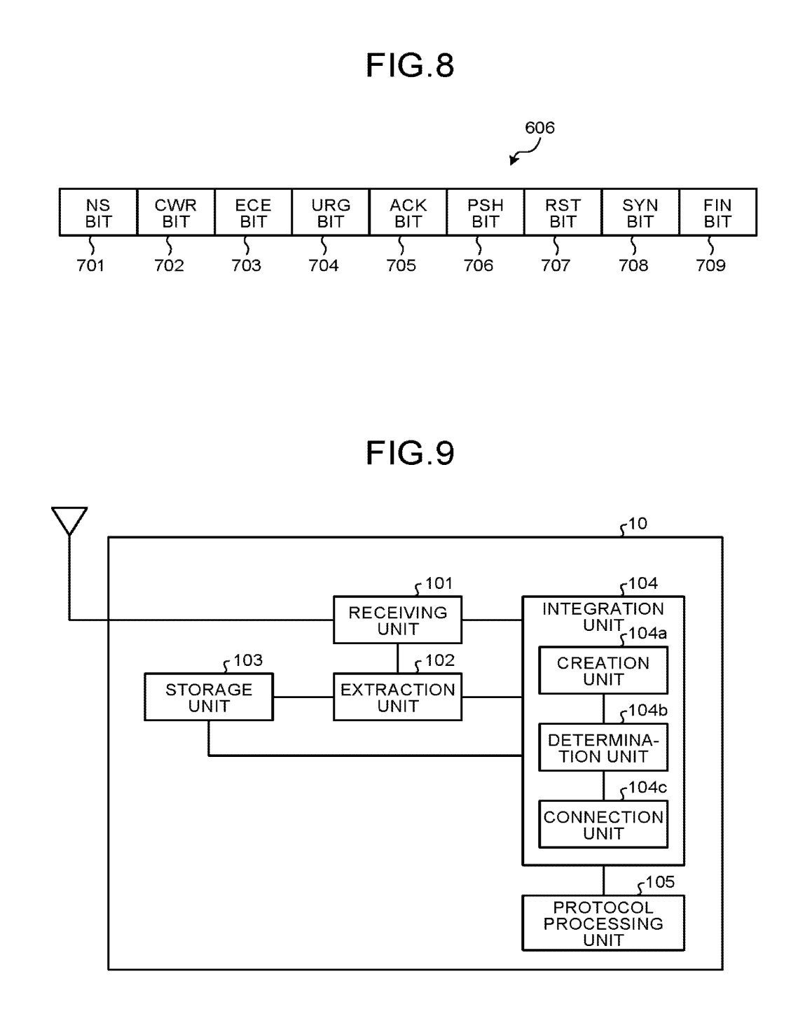

FIGS. 3A and 3B are diagrams illustrating structures of a physical layer frame and a subframe. FIG. 4 is a diagram illustrating a structure of a MAC header. FIG. 5 is a diagram illustrating a structure of an LLC header. FIG. 6 is a diagram illustrating a structure of an IP header. FIG. 7 is a diagram illustrating a structure of a TCP header. FIG. 8 is a diagram illustrating a structure of a flag field of the TCP header. The following describes the structure of communication data wirelessly communicated between the communication terminal 10 and the access point 20 with reference to FIGS. 3 to 8.

First, the structures of a physical layer frame 201 (aggregated frame) and subframes 212 will be described with reference to FIGS. 3A and 3B. FIG. 3A is a diagram illustrating the structure of the physical layer frame 201 constituting the communication data wirelessly communicated between the communication terminal 10 and the access point 20. The physical layer frame 201 is data to be subjected to protocol processing at a physical layer. As illustrated in FIG. 3A, in the physical layer frame 201, the subframes 212 (subframes 212_1, 212_2, . . . , 212_n) are concatenated following a physical layer header 211. That is, the physical layer frame 201 has a structure in which the subframes 212 are aggregated. Each of the subframes 212 may contain data of any one of various upper layer protocols (such as TCP/IP or User Datagram Protocol (UDP)/IP) as a payload. In general, multiple protocol data units of different upper layer protocols are concatenated as the subframes 212 in the physical layer frame 201.

FIG. 3B is a diagram illustrating the structure of the subframe 212 that is included in the physical layer frame 201 and includes a TCP segment 226 as the payload. The subframe 212 is data to be subjected to the protocol processing at a data link layer serving as an upper layer of the physical layer. As illustrated in FIG. 3B, the subframe 212 includes a MAC header 221, an LLC header 222, an IP header 223, a TCP header 224, and segment data 225. Herein, the TCP segment 226 refers to data consisting of the TCP header 224 and the segment data 225 to be subjected to TCP processing. A header portion serving as a data body portion (including the MAC header 221, the LLC header 222, the IP header 223, and the TCP header 224) other than the segment data 225 of the subframe 212 is referred to as a subframe header 220.

The MAC header 221 is information added for the subframe 212 to perform protocol processing of a media access control (MAC) sublayer of the data link layer. The LLC header 222 is information added for the subframe 212 to perform protocol processing of a logical link control (LLC) sublayer of the data link layer.

The IP header 223 is information added for a packet included in the subframe 212 to perform IP processing of a network layer. The term “packet” refers to data that is subject to the IP processing, which consists of the IP header 223, the TCP header 224, and the segment data 225.

The TCP header 224 is information added for the TCP segment included in the subframe 212 to perform TCP processing of a transport layer.

The segment data 225 is data to be actually wirelessly communicated between the communication terminal 10 and the access point 20. After the subframe 212 is subjected to various types of protocol processing, the segment data 225 is transferred to, for example, an application.

The following describes the structure of the MAC header 221 with reference to FIG. 4. As illustrated in FIG. 4, the MAC header 221 includes eight fields: a frame control 301, a duration/ID 302, an address (1) 303, an address (2) 304, an address (3) 305, a sequence control 306, an address (4) 307, and a quality of service (QoS) control 308.

The frame control 301 includes, for example, information on the frame type of the subframe 212, the destination of the frame, and whether the source is a wireless or a wired source, fragment information, and power management information. The duration/ID 302 includes information used, for example, in request to send/clear to send (RTS/CTS) communication.

The address (1) 303, the address (2) 304, the address (3) 305, and the address (4) 307 include information on, for example, the MAC address of a destination, the MAC address of a source, and the MAC address of an access point (basic service set identifier (BSSID)).

The sequence control 306 includes information on the sequence number of transmitted data or the fragment number thereof, if fragmented. The QoS control 308 includes information on QoS.

The MAC header 221 always includes the frame control 301, the duration/ID 302, and the address (1) 303. However, the MAC header 221 includes or does not include the address (2) 304, the address (3) 305, the sequence control 306, the address (4) 307, and the QoS control 308, depending on the case. Determination as to whether the MAC header 221 includes or does not include the address 304, the address (3) 305, the sequence control 306, the address (4) 307, and the QoS control 308 is made based on the information in the frame control 301.

The following describes the structure of the LLC header 222. As illustrated in FIG. 5, the LLC header 222 includes a destination service access point (SAP) 401, a source SAP 402, a control byte 403, an organizationally unique identifier (OUI) 404, and a protocol ID 405.

The destination SAP 401 is information indicating a service of the transmission destination. The source SAP 402 is information indicating a service of the transmission source. The control byte 403 is various types of control information. The OUI 404 is information indicating the front part of the MAC address. The protocol ID 405 is information indicating a number for identifying what the upper layer protocol is.

The field for the OUI 404 and the protocol ID 405 is a Subnetwork Access Protocol (SNAP) extension field, and is included in the LLC header 222 only when the destination SAP 401 and the source SAP 402 represent values indicating the SNAP extension field.

The following describes the structure of the IP header 223. As illustrated in FIG. 6, the IP header 223 includes a version 501, a header length 502, a service type 503, an overall length 504, an identifier 505, a flag 506, a fragment position 507, a time to live 508, a protocol 509, a checksum 510, a source address 511, a destination address 512, and an extended information 513.

The version 501 is information indicating IPv4 when having a value of “4”, or IPv6 when having a value of “6”. The header length 502 is information indicating the length of the IP header 223. The service type 503 stores a value for determining the order of priority of the packet.

The overall length 504 is information indicating the overall length of the packet including the IP header 223. The identifier 505 is information for identifying whether the packet is data fragmented from what was originally the same packet or completely independent data. For example, the identifiers 505 in the IP header 223 of fragmented data all have the same value.

The flag 506 is information used for controlling the fragmentation of the packet, when fragmentation is being used. The fragment position 507 is information indicating where the fragmented packet is located in the original data. The time to live 508 is information that has a value basically decremented by “1” each time the pack passes through a router, and indicates that the packet should be discarded when the value reaches “0”.

The protocol 509 is information indicating a protocol (such as TCP or UDP) of the upper layer of the network layer. The checksum 510 is information for checking whether the packet has an error.

The source address 511 is information indicating the IP address of the transmission source. The destination address 512 is information indicating the IP address of the destination. The extended information 513 is information specifying options that are appended to the packet.

The following describes the structure of the TCP header 224 with reference to FIG. 7. As illustrated in FIG. 7, the TCP header 224 includes a source port 601, a destination port 602, a sequence number 603, an acknowledgment number 604, a header length 605, a flag 606, a window size 607, a header checksum 608, an urgent pointer 609, and options 610.

The source port 601 is information indicating a port number for identifying an application at the transmission source. The destination port 602 is information indicating a port number for identifying an application at the destination.

The sequence number 603 is information indicating a number for sequencing the transmitted data. The acknowledgment number 604 is information representing a byte address indicating to what extent the data to be received has been successfully received.

The header length 605 is information indicating the size of the TCP header 224. The flag 606 is information used as various flags. The detailed structure of the flag 606 will be described later with reference to FIG. 8.

The window size 607 is information used for notifying a communication partner of the window size on the receiving side. The header checksum 608 is information representing data for checking consistency of the TCP segment. The urgent pointer 609 is information that is valid only when a URG bit 704 illustrated in FIG. 8 is “1”, and indicates a location of urgent data. The options 610 are variable-length information used for setting characteristics of a TCP connection. If the value of the header length 605 is “5”, the options 610 are omitted.

The following describes the structure of the flag 606 in the TCP header 224. As illustrated in FIG. 8, the flag 606 includes an NS bit 701, a CWR bit 702, an ECE bit 703, a URG bit 704, an ACK bit 705, a PSH bit 706, an RST bit 707, an SYN bit 708, and an FIN bit 709.

The CWR bit 702 is a flag for notifying the communication partner of a reduction in a congestion window. The ECE bit 703 is a flag for notifying the communication partner of an occurrence of congestion.

The URG bit 704 is a flag for indicating that the urgent data is included. The ACK bit 705 is a flag for indicating that the TCP header 224 includes a valid acknowledgment number 604. The PSH bit 706 is flag for requesting the received data to be immediately transferred to the application.

The RST bit 707 is a flag that is set when the TCP connection is to be aborted or rejected. The SYN bit 708 is a flag that is turned on by each of the communication partners to synchronize the acknowledgment number 604 when open processing is started during a three-way handshake in TCP. The FIN bit 709 is a flag that is set to end the TCP connection.

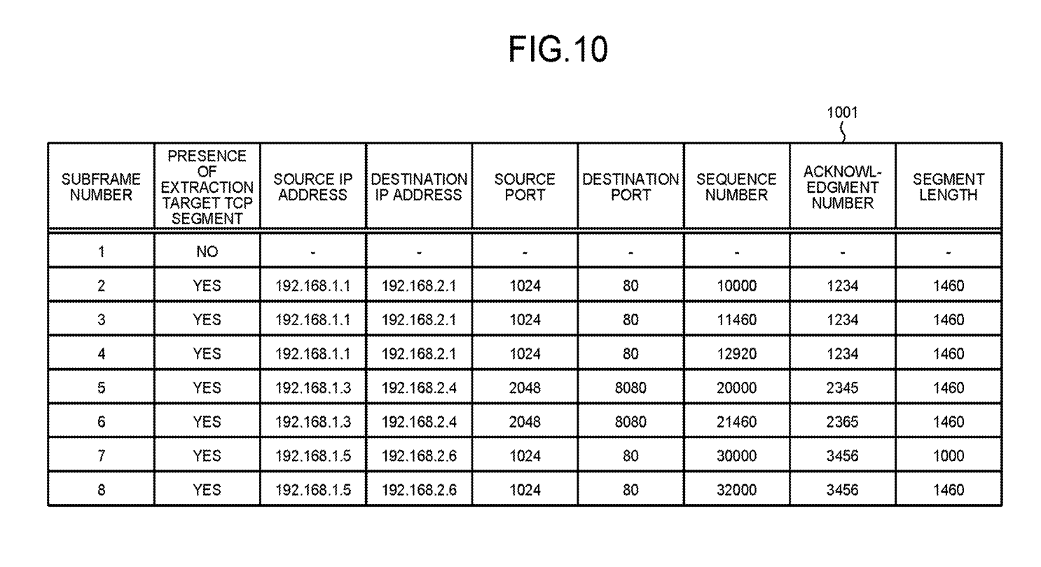

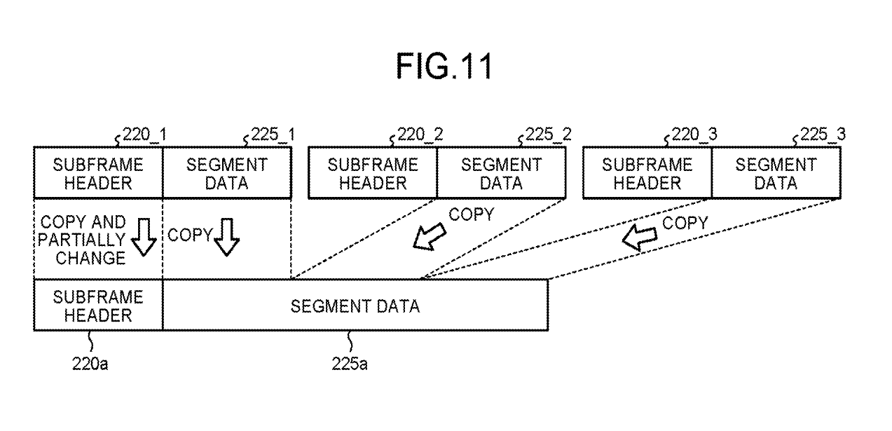

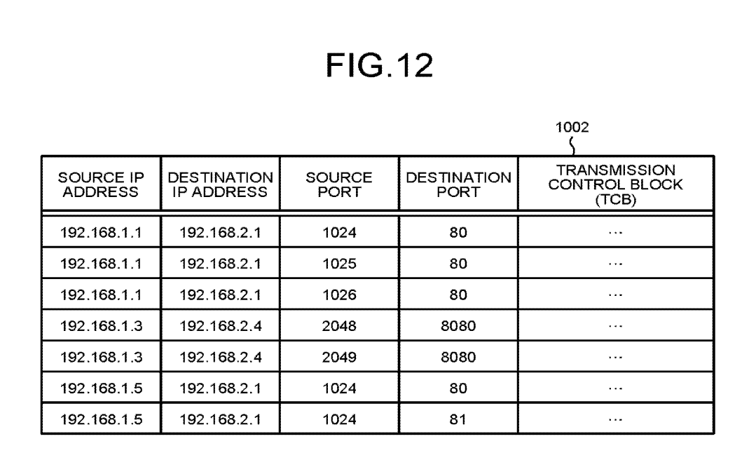

FIG. 9 is a diagram illustrating an example of a functional block configuration of the communication terminal of the first embodiment. FIG. 10 is a diagram illustrating an example of a structure of a subframe information table. FIG. 11 is a diagram explaining an operation of connecting the subframes. FIG. 12 is a diagram illustrating an example of a structure of a TCB information table. The following describes the configuration and operations of the functional blocks of the communication terminal 10 according to the present embodiment with reference to FIGS. 9 to 12.

As illustrated in FIG. 9, the communication terminal 10 according to the first embodiment includes a receiving unit 101, an extraction unit 102, a storage unit 103, an integration unit 104, and protocol processing unit 105 (processing unit).

The receiving unit 101 is a functional unit for receiving the data (physical layer frame 201) through the wireless communication from the access point 20. The receiving unit 101 is implemented by the communication interface 901 and the antenna 901a illustrated in FIG. 2.

The extraction unit 102 is a functional unit for extracting the subframes 212 included in the received physical layer frame 201.

The storage unit 103 is a functional unit for storing, as will be described below, a subframe information table 1001 illustrated in FIG. 10 that has been created by a creation unit 101a of the integration unit 104. The storage unit 103 is implemented by the RAM 904 or the auxiliary storage device 905 illustrated in FIG. 2.

The integration unit 104 is a functional unit for integrating the subframes 212 extracted by the extraction unit 102. The integration unit 104 includes the creation unit 104a, a determination unit 104b, and a connection unit 104c.

The creation unit 104a is a functional unit for creating the subframe information table 1001 illustrated in FIG. 10 using values in the respective fields in the subframe headers 220 of the subframes 212 extracted by the extraction unit 102. The creation unit 104a stores the subframe information table 1001 thus created in the storage unit 103. Each row of the subframe information table 1001 illustrated in FIG. 10 corresponds to information on each of the subframes 212 extracted by the extraction unit 102. As illustrated in FIG. 10, the subframe information table 1001 has the following fields (columns): “Subframe number”, “Presence of extraction target TCP segment”, “Source IP address”, “Destination IP address”, “Source port”, “Destination port”, “Sequence number”, “Acknowledgment number”, and “Segment length”.

“Subframe number” represents a number for identifying each of the subframes 212 extracted by the extraction unit 102.

“Presence of extraction target TCP segment” represents information indicating a determination based on the content of the subframe header 220 of each of the subframes 212 as to whether the subframe 212 includes a TCP segment 226, and, if so, whether the segment data 225 of the TCP segment 226 is connectable with the segment data 225 of another TCP segment 226. “No” in the field of “Presence of extraction target TCP segment” indicates that the subframe 212 does not include the TCP segment 226, or that the segment data 225 of the TCP segment 226 is not connectable with the segment data 225 of another TCP segment 226 although the subframe 212 includes the TCP segment 226. In contrast, “Yes” in the field of “Presence of extraction target TCP segment” indicates that the subframe 212 includes the TCP segment 226, and the segment data 225 of the TCP segment 226 is connectable with the segment data 225 of another TCP segment 26.

The creation unit 104a determines whether the subframe 212 includes a TCP segment 226 by determining whether all the following conditions (1) to (8) are satisfied. If all the following conditions (1) to (8) are satisfied, the creation unit 104a determines that the subframe 21 includes a TCP segment 226.

(1) The value of the frame control 301 in the MAC header 221 indicates a data frame.

(2) The LLC header 222 includes the SNAP extension field.

(3) The value of the OUI 404 in the LLC header 222 is “0”.

(4) The value of the protocol ID 405 in the LLC header 222 indicates IPv4 or IPv6.

(5) The value of the version 501 in the LLC header 222 indicates IPv4 or IPv6.

(6) The value of the protocol 509 in the IP header 223 indicates TCP.

(7) The value of the fragment position 507 in the IP header 223 is “0”.

(8) When the values of the header length 502 in the IP header 223 and the header length 605 in the TCP header 224 are subtracted from the overall length of the packet, that is, the value of the overall length 504 in the IP header 223, the result is larger than “0”.

If the creation unit 104a determines that the subframe 212 does not include a TCP segment 226, the creation unit 104a writes “No” into the column of “Presence of extraction target TCP segment” of a row corresponding to the subframe 212 in the subframe information table 1001.

The creation unit 104a determines whether the segment data 225 of the TCP segment 226 is connectable with the segment data 225 of another TCP segment 226 by determining whether all the conditions (11) to (13) described below are satisfied. If the creation unit 104a determines that the subframe 212 includes a TCP segment 226, and that the segment data 225 of the TCP segment 226 is connectable with the segment data 225 of another TCP segment 226, the creation unit 104a writes “Yes” into the column of “Presence of extraction target TCP segment” of the row corresponding to the subframe 212 in the subframe information table 1001. If the creation unit 104a determines that the segment data 225 of a TCP segment 226 is not connectable with the segment data 225 of another TCP segment 226 although the subframe 212 includes the TCP segment 226, the creation unit 104a writes “No” into the column of “Presence of extraction target TCP segment” of the row corresponding to the subframe 212 in the subframe information table 1001.

(11) The extended information 513 in the IP header 223 is omitted.

(12) The IP packet is not fragmented; that is, the flag 506 in the IP header 223 does not indicate presence of a subsequent fragment, and the value of the fragment position 507 in the IP header 223 is “0”.

(13) The ACK bit 705 of the flag 606 in the TCP header 224 is “1”, and the URG bit 704, the RST bit 707, the SYN bit 708, and the FIN bit 709 are all “0”.

If the column of “Presence of extraction target TCP segment” in the subframe information table 1001 has a value “No”, the corresponding subframe 212 does not necessarily have a TCP segment, so that values in the other columns of the subframe information table 1001 are meaningless. If, instead, the column of “Presence of extraction target TCP segment” in the subframe information table 1001 has a value “Yes”, the creation unit 104a writes the following values into the other columns of a row corresponding to each of the subframes 212. The creation unit 104a writes the source address 511 in the IP header 223 into the column of “Source IP address”. The creation unit 104a writes the destination address 512 in the IP header 223 into the column of “Destination IP address”. The creation unit 104a writes the source port 601 in the TCP header 224 into the column of “Source port”. The creation unit 104a writes the destination port 602 in the TCP header 224 into the column of “Destination port”. The creation unit 104a writes the sequence number 603 in the TCP header 224 into the column of “Sequence number”. The creation unit 104a writes the acknowledgment number 604 in the TCP header 224 into the column of “Acknowledgment number”. The creation unit 104a writes, into the column of “Segment length”, a value, converted to number of octets, of the value obtained by subtracting the values of the header length 502 in the IP header 223 and the header length 605 in the TCP header 224 from the value of the overall length 504 in the IP header 223.

The form of the subframe information table 1001 illustrated in FIG. 10 is merely an example. Any form can be used, provided that the information defines the correspondence relations of the columns described above.

The determination unit 104b is a functional unit for specifically determining whether two or more subframes 212 are subframes 212 having the segment data 225 connectable with one another by determining whether values in rows corresponding to the two or more subframes 212 extracted by the extraction unit 102 satisfy all the following conditions (21) to (23), with reference to the subframe information table 1001. If all the following conditions (21) to (23) are satisfied, the determination unit 104b determines that the two or more subframes 212 are subframes 212 having the segment data 225 connectable with one another.

(21) The values in the column of “Presence of extraction target TCP segment”” in the subframe information table 1001 are all “Yes”.

(22) The values in each of the columns of “Source IP address”, “Destination IP address”, “Source port”, “Destination port”, and “Acknowledgment number” in the subframe information table 1001 are the same as one another.

(23) First, the subframes 212 to be determined as to the connectability are sorted in ascending order of “Sequence number”. Then, subframes 212 other than a subframe 212 having the largest value of “Sequence number” are selected from the sorted subframes 212. When the value of “Segment length” of each of the selected subframes 212 is added to the value of “Sequence number” of the same subframe 212, the result coincides with the value of “Sequence number” of a subframe 212 that comes next in the ascending order.

The connection unit 104c is a functional unit for connecting the two or more subframes 212 determined by the determination unit 104b to have the connectable segment data 225. For example, if the determination unit 104b determines that a subframe constituted by a subframe header 220_1 and a segment data 225_1, a subframe constituted by a subframe header 220_2 and a segment data 225_2, and a subframe constituted by a subframe header 220_3 and a segment data 225_3 are connectable with one another, the connection unit 104c generates, for example, a new subframe header 220a by copying the subframe header 220_1 and partially changing the content thereof, as illustrated in FIG. 11. The connection unit 104c then copies and connects the segment data 225_1, 225_2, and 225_3 to generate new segment data 225a. The connection unit 104c then combines the newly generated subframe header 220a and segment data 225a to generate a new connected subframe.

To describe it more specifically, the connection unit 104c copies the subframe header 220 of one subframe 212 (for example, a subframe 212 having the smallest sequence number 603) among the subframes 212 (hereinafter, called the “series of subframes 212” in the first embodiment) that are determined by the determination unit 104b to have connectable segment data 225, and changes the value of the sequence number 603 in the TCP header 224 of the copied subframe header 220 to the value of the smallest sequence number 603 among those of the series of subframes 212. The connection unit 104c then changes the value of the overall length 504 in the IP header 223 of tho copied subframe header 220 to the total value obtained from the total of the segment lengths (values of “Segment length” in the subframe information table 1001) of the series of subframes 212, the header length 502 in the IP header 223 of the copied subframe header 220, and the header length 605 in the TCP header 224 of the copied subframe header 220. Then, if the PSH bit (or bits) 706 of the flag (or flags) 606 in the TCP header (or headers) 224 of one or more subframes 212 of the series of subframes 212 is (are) “1”, the connection unit 104c changes the PSH bit 706 of the flag 606 in the TCP header 224 of the copied subframe header 220 to “1”. The connection unit 104c then re-calculates the header checksum 608 in the TCP header 224 of the copied subframe header 220, and changes the value of the header checksum 608 to the re-calculated value. Then, the connection unit 104c copies the segment data 225 of the series of subframes 212, and connects the copied segment data 225 behind the copied subframe header 220 in ascending order of sequence number 603 of each of the subframes 212. Furthermore, the connection unit 104c calculate a checksum of the copied subframe header 220 (subframe header 220a illustrated in FIG. 11) and the connected segment data (segment data 225a illustrated in FIG. 11), and changes the value of the checksum 510 in the IP header 223 of the copied subframe header 220 to the checksum thus calculated.

The protocol processing unit 105 is a functional unit for performing the protocol processing, such as the IP processing and the TCP processing, on the subframe connected by the connection unit 104c, using, for example, a TCP/IP stack built into a general-purpose OS. In general, the TCP/IP stack keeps information on the state of the TCP connection as internal variables in a TCB. Each of a plurality of such TCP connections identified using four values of the source IP address, the destination IP address, the source port, and the destination port as identification information. Hence, the protocol processing unit 105 searches for the TCB based on the identification information in identification of the TCP connection as the TCP processing. TCB information table 1002 illustrated in FIG. 12 exemplifies a data structure used by the TCP/IP stack in the protocol processing unit 105 to search for the TCB. Each row of the TCB information table 1002 illustrated in FIG. 12 serves as information corresponding to one TCP connection. The protocol processing unit 105 refers to a corresponding TCB based on the four values of the source IP address, the destination IP address, the source port, and the destination port included in each of the received subframes 212. The data structure for searching for the TCB may be a data structure of, for example, a hash table, instead of the simple table form, such as that of the TCB information table 1002 of FIG. 12.

Instead of actually copying the segment data 225 of the series of subframes 212, the connection unit 104c may create a list of addresses and lengths of the segment data 225 of the series of subframes 212 stored in the storage unit 103, and transmit the list to the protocol processing unit 105. In this case, the protocol processing unit 105 only needs to read the segment data 225 from the addresses listed in the list received from the connection unit 104c and use the segment data 225 thus read.

The subframe information table 1001 created by the creation unit 104a regarding the received physical layer frame 201 may be deleted after the end of the protocol processing performed by the protocol processing unit 105.

The CPU 902 implements the extraction unit 102, the integration unit 104, and the protocol processing unit 105 described above by executing a program stored in the ROM 903 or the auxiliary storage device 905 illustrated in FIG. 2. Instead of the program which is software, a hardware circuit, such as an application-specific integrated circuit (ASIC), may implement part or all of the extraction unit 102, the integration unit 104, and the protocol processing unit 105.

The receiving unit 101, the extraction unit 102, the storage unit 103, the creation unit 104a, the determination unit 104b, the connection unit 104c, and the protocol processing unit 105, which have been described above, are conceptual functions, and need not be configured as these units. For example, a plurality of functional units illustrated in FIG. 9 as independent functional units may be configured as one functional unit. By contrast, one of the functional units of FIG. 9 may be divided in terms of the function thereof so as to be configured as a plurality of functional units.

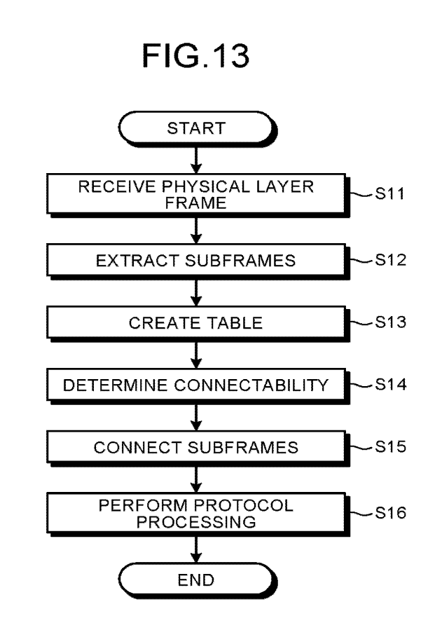

FIG. 13 is a flowchart illustrating an example of received data processing of the first embodiment. The following describes, with reference to FIG. 13, an operation of the processing (received data processing) performed by the communication terminal 10 according to the present embodiment when the communication terminal 10 has received the physical layer frame 201.

Step S11

The receiving unit 101 receives the data (physical layer frame 201) through the wireless communication from the access point 20. The receiving unit 101 transmits the received physical layer frame 201 to the extraction unit 102. Then, the flow proceeds to Step S12.

Step S12

The extraction unit 102 extracts a plurality of subframes 212 included in the physical layer frame 201 received from the receiving unit 101. Then, the flow proceeds to Step S13.

Step S13

The creation unit 104a creates the subframe information table 1001 illustrated in FIG. 10 using values in the respective fields in the subframe headers 220 of the subframes 212 extracted by the extraction unit 102. The creation unit 104a stores the subframe information table 1001 thus created in the storage unit 103. The information written by the creation unit 104a in the columns of the subframe information table 1001 is as described above. Then, the flow proceeds to Step S14.

Step S14

The determination unit 104b determines whether the two or more subframes 212 are subframes 212 having the segment data 225 connectable with one another by determining whether values in rows corresponding to the two or more subframes 212 extracted by the extraction unit 102 satisfy all the above-described conditions (21) to (23), with reference to the subframe information table 1001. Then, the flow proceeds to Step S15.

Step S15

The connection unit 104c connects the two or more subframes 212 determined by the determination unit 104b to have the connectable segment data 225. The specific operation of connecting the subframes 212 by the connection unit 104c is as described above. The connection unit 104c transmits the new subframe generated by the connection to the protocol processing unit 105. Then, the flow proceeds to Step S16.

Step S16

The protocol processing unit 105 performs the protocol processing, such as the IP processing and the TCP processing, on the subframe connected by the connection unit 104c.

As describe above, the communication terminal 10 according to the present embodiment extracts a plurality of subframes 212 included in the physical layer frame 201, determines whether the segment data 225 of the series of subframes 212 is connectable with one another based on the values in the subframe headers 220 of the respective subframes 212, and connects the subframes 212 determined to be connectable to generate the new subframe. As a result of this operation, the protocol processing unit 105 only needs to perform the protocol processing on the new subframe integrated by being connected by the integration unit 104, and need not perform the protocol processing on each of the original subframes 212. Consequently, the protocol processing can be performed with a lower load than in the case of performing the protocol processing on each of the original subframes 212, and thus, the processing efficiency can be increased. The load of the protocol processing can decrease as the number of the connectable subframes 212 increases.

The creation of the subframe information table 1001 performed by the creation unit 104a can facilitate the determination processing performed by the determination unit 104b to determine whether the two or more subframes 212 are subframes 212 having the segment data 225 connectable with one another.

As described above, the communication terminal 10 processes the physical layer frame 201 received through the wireless communication with the access point 20. However, the processing performed by the communication terminal 10 is not limited to such processing. That is, the communication terminal 10 can apply the received data processing described above to a case where data in the same form as that of the physical layer frame 201 illustrated in FIG. 3 is externally received through wired communication.

### Second Embodiment

A communication terminal according to a second embodiment will be described by focusing on differences thereof from the communication terminal 10 according to the first embodiment. In the first embodiment, the operation has been described in which the subframes 212 included in the physical layer frame 201 are connected to be integrated. In the present embodiment, an operation will be described in which the subframes 212 included in the physical layer frame 201 are rearranged, and identification information is added. The overall configuration of a communication system, the hardware configuration of a communication device, and the structure of the physical layer frame 201 as the communication data according to the present embodiment are the same as those described in the first embodiment.

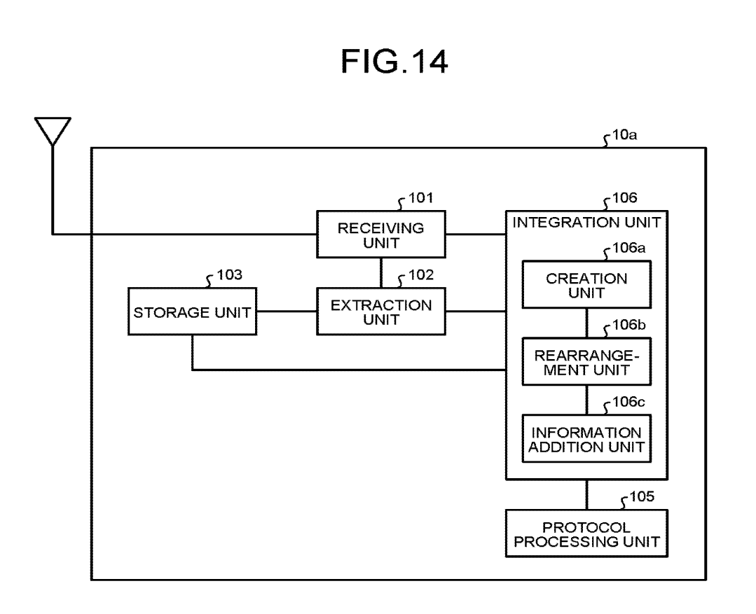

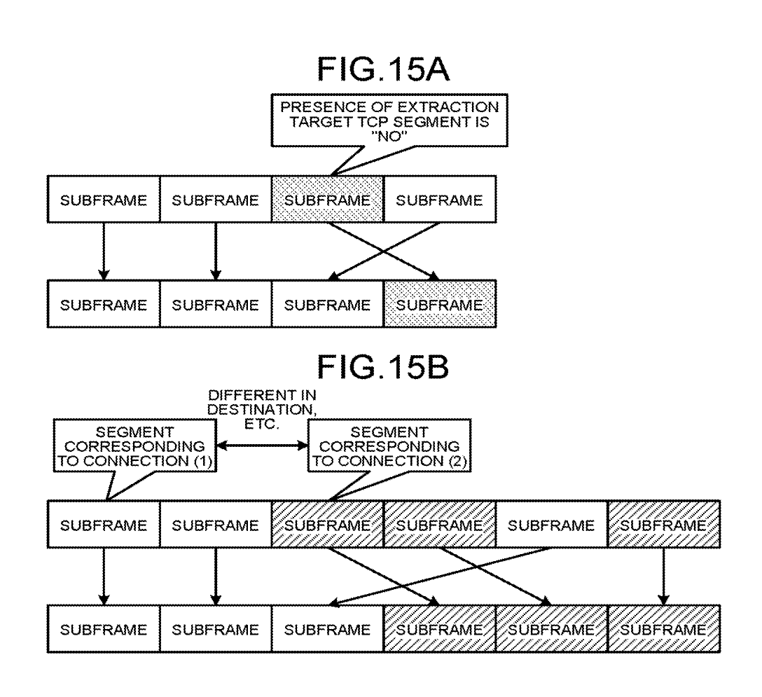

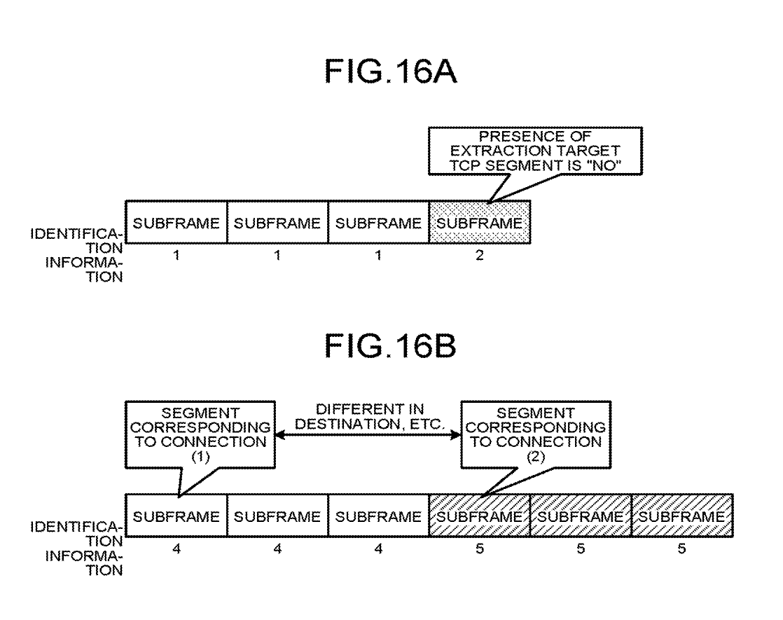

FIG. 14 is a diagram illustrating an example of a functional block configuration of the communication terminal of the second embodiment. FIGS. 15A and 15B are diagrams explaining operations of rearranging the subframes. FIGS. 16A and 16B are diagrams explaining operations of adding the identification information to the subframes. The following describes the configuration and operations of the functional blocks of a communication terminal 10a according to the present embodiment with reference to FIGS. 14 to 16B.

As illustrated in FIG. 14, the communication terminal 10a according to the second embodiment includes the receiving unit 101, the extraction unit 102, the storage unit 103, the protocol processing unit 105 (processing unit), and an integration unit 106.

The receiving unit 101 is a functional unit for receiving the data (physical layer frame 201) through the wireless communication from the access point 20. The receiving unit 101 is implemented by the communication interface 901 and the antenna 901a illustrated in FIG. 2.

The extraction unit 102 is a functional unit for extracting the subframes 212 included in the received physical layer frame 201.

The storage unit 103 is a functional unit for storing, as will be described below, the subframe information table 1001 illustrated in FIG. 10 that has been created by a creation unit 106a of the integration unit 106. The storage unit 103 is implemented by the RAM 904 or the auxiliary storage device 905 illustrated in FIG. 2.

The integration unit 106 is a functional unit for integrating the subframes 212 extracted by the extraction unit 102. The integration unit 106 includes the creation unit 106a, a rearrangement unit 106b, and an information addition unit 106c.

The creation unit 106a is a functional unit for creating the subframe information table 1001 illustrated in FIG. 10 using the values in the respective fields in the subframe headers 220 of the subframes 212 extracted by the extraction unit 102. The creation unit 106a stores the subframe information table 1001 thus created in the storage unit 103. The specific operation of writing the subframe information table 1001 performed by the creation unit 106a is the same as the specific operation performed by the creation unit 104a described above in the first embodiment.

The rearrangement unit 106b is a functional unit for rearranging, with reference to the subframe information table 1001, the subframes 212 extracted by the extraction unit 102 so that the subframes 212 having the same type of segment data 225 (that is, corresponding to the same TCP connection) are arranged contiguously. Specifically, the rearrangement unit 106b first refers to the subframe information table 1001, and specifically determines whether the two or more subframes 212 are subframes 212 having the same type of segment data 225 by determining whether values in rows corresponding to the two or more subframes 212 extracted by the extraction unit 102 satisfy both the above-described conditions (21) and (22). In the following description, the subframes 212 determined to have the same type of segment data 225 will be called the “series of subframes 212” in the second embodiment. Then, the rearrangement unit 106b moves a subframe 212 having “No” in the column of “Presence of extraction target TCP segment” of the subframe information table 1001 to behind the last subframe 212 of the series of subframes 212 (alternatively, to the front of the first subframe 212 of the series of subframes 212), as illustrated in FIG. 15A. As a result, the series of subframes 212 are arranged contiguously as illustrated in FIG. 15A.

As illustrated in FIG. 15B, if a plurality of types of series of subframes 212 (in the example of FIG. 15B, a group of subframes 212 corresponding to a connection (1) and a group of subframes 212 corresponding to a connection (2)) are present, the rearrangement unit 106b moves one series of subframes 212 located between subframes of another series of subframes 212 to behind the last subframe 212 of the other series of subframes 212. FIG. 15B illustrates the example in which the rearrangement unit 106b moves the series of subframes 212 corresponding to the connection (2) located between subframes of the series of subframes 212 corresponding to the connection (1) that is a TCP connection to behind the last subframe 212 of the series of subframes 212 corresponding to the connection (1). As a result, the subframes of each series of subframes 212 determined to have the same type of segment data 225 are arranged contiguously.

Instead of actually copying the segment data 225 of the series of subframes 212, the rearrangement unit 106b may create a list of addresses and lengths of the segment data 225 of the series of subframes 212 stored in the storage unit 103, and transmit the list to the information addition unit 106c and the protocol processing unit 105. In this case, the information addition unit 106c and the protocol processing unit 105 only need to read the segment data 225 from the addresses listed in the list received from the rearrangement unit 106b and use the segment data 225 thus read.

The information addition unit 106c is a functional unit for adding the identification information for distinguishing a series of subframes 212 from other series of subframes 212 to each of the subframes 212 rearranged by the rearrangement unit 106b. The information addition unit 106c adds the identification information having the same value to each subframe of the series of subframes 212 rearranged by the rearrangement unit 106b, and, if another series of subframes 212 is present behind the last subframe 212 of the rearranged series of subframes 212, the information addition unit 106c adds identification information having a different value (for example, identification information obtained by adding “1” to the value of the identification information added to the preceding series of subframes 212) to each subframe in the other series of subframes 212.

FIG. 16A illustrates an example in which the information addition unit 106c adds identification information “1” to each subframe of the series of subframes 212 that are located in front after being rearranged by the rearrangement unit 106b as illustrated in FIG. 15A, and adds identification information “2” to the subframe 212 that is located behind and has “No” in the column of “Presence of extraction target TCP segment”. FIG. 16B illustrates an example in which the information addition unit 106c adds identification information “4” to each subframe of the series of subframes 212 corresponding to the connection (1) that are located in front after being rearranged by the rearrangement unit 106b as illustrated in FIG. 15B, and adds identification information “5” to each subframe of the series of subframes 212 corresponding to the connection (2) that are located behind.

The information addition unit 106c adds the identification information for identifying the series of subframes 212. However, the embodiments are not limited to this method. Another method can be employed in which a flag is added that indicates whether a subframe 212 and another subframe 212 immediately preceding it belong to the same series of subframes 212, and the flag is used as identification information.

The protocol processing unit 105 is a functional unit for performing the protocol processing, such as the IP processing and the TCP processing, on the subframes 212 to which the identification information has been added by the information addition unit 106c, using, for example, a TCP/IP stack built into a general-purpose OS. In this processing, when performing the identification of The TCP connection as the TCP processing, the protocol processing unit 105 can determine, based on the identification information added by the information addition unit 106c, whether the subframes 212 to be processed belong to the same series of subframes 212. Accordingly, the protocol processing unit 105 only needs to use a TCB found for the first subframe 212 without changing it to another TCB for the second and subsequent subframes 212 in the series of subframes 212, instead of searching for TCBs in the subframe information table 1002 for the second and subsequent subframes 212.

The CPU 902 implements the extraction unit 102, the integration unit 106, and the protocol processing unit 105 described above by executing a program stored in the ROM 903 or the auxiliary storage device 905 illustrated in FIG. 2. Instead of the program which is software, a hardware circuit, such as an ASIC, may implement part or all of the extraction unit 102, the integration unit 106, and the protocol processing unit 105.

The receiving unit 101, the extraction unit 102, the storage unit 103, the creation unit 106a, the rearrangement unit 106b, the information addition unit 106c, and the protocol processing unit 105, which have been described above, are conceptual functions, and need not be configured as these units. For example, a plurality of functional units illustrated in FIG. 9 as independent functional units may be configured as one functional unit. For example, a plurality of functional units illustrated in FIG. 14 as independent functional units may be configured as one functional unit. By contrast, one of the functional units of FIG. 14 may be divided in terms of the function thereof so as to be configured as a plurality of functional units.

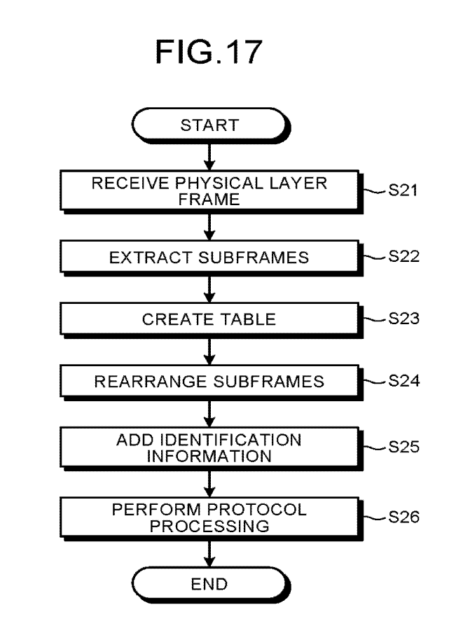

FIG. 17 is a flowchart illustrating an example of received data processing of the second embodiment. The following describes, with reference to FIG. 17, an operation of the processing (received data processing) performed by the communication terminal 10a according to the present embodiment when the communication terminal 10a has received the physical layer frame 201.

Step S21

The receiving unit 101 receives the data (physical layer frame 201) through the wireless communication from the access point 20. The receiving unit 101 transmits the received physical layer frame 201 to the extraction unit 102. Then, the flow proceeds to Step S22.

Step S22

The extraction unit 102 extracts the subframes 212 included in the received physical layer frame 201.

Step S23

The creation unit 106a creates the subframe information table 1001 illustrated in FIG. 10 using values in the respective fields in the subframe headers 220 of the subframes 212 extracted by the extraction unit 102. The creation unit 106a stores the subframe information table 1001 thus created in the storage unit 103. The information written by the creation unit 106a in the columns of the subframe information table 1001 is as described above. Then, the flow proceeds to Step S24.

Step S24

With reference to the subframe information table 1001, the rearrangement unit 106b rearranges the subframes 212 extracted by the extraction unit 102 so that the subframes 212 having the same type of segment data 225 are arranged contiguously. As a result, the subframes of each series of subframes 212 determined to have the same type of segment data 225 are arranged contiguously. Then, the flow proceeds to Step S25.

Step S25

The information addition unit 106c adds the identification information for distinguishing a series of subframes 212 from other series of subframes 212 to each of the subframes 212 rearranged by the rearrangement unit 106b. The information addition unit 106c adds the identification information having the same value to each subframe of the series of subframes 212 rearranged by the rearrangement unit 106b, and, if another series of subframes 212 is present behind the last subframe 212 of the rearranged series of subframes 212, the information addition unit 106c adds identification information having a different value to each subframe in the other series of subframes 212. Then, the flow proceeds to Step S26.

Step S26

The protocol processing unit 105 performs the protocol processing, such as the IP processing and the TCP processing, on the subframes 212 to which the identification information has been added by the information addition unit 106c. In this processing, when performing the identification of the TCP connection as the TCP processing, the protocol processing unit 105 can determine, based on the identification information added by the information addition unit 106c, whether the subframes 212 to be processed belong to the same series of subframes 212. Accordingly, the protocol processing unit 105 only needs to use a TCB found for the first subframe 212 without changing it to another TCB for the second and subsequent subframes 212 in the series of subframes 212, instead of searching for TCBs in the subframe information table 1002 for the second and subsequent subframes 212.

As describe above, the communication terminal 10a according to the present embodiment extracts a plurality of subframes 212 included in the physical layer frame 201, determines, based on the values in the subframe headers 220 of the respective subframes 212, whether the subframes 212 have the same type of segment data 225, rearranges the subframes 212 so that the subframes 212 having the same type of segment data 225 are arranged contiguously, adds the identification information having the same value to each subframe of the series of subframes 212, and, if another series of subframes 212 is present, adds identification information having a different value to each subframe in the other series of subframes 212. As a result of this operation, when the protocol processing unit 105 performs the identification processing of the TCP connection, the protocol processing unit 105 can determine, based on the identification information added by the information addition unit 106c, whether the subframes 212 to be processed belong to the same series of subframes 212. Accordingly, the protocol processing unit 105 only needs to use a TCB found for the first subframe 212 without changing it to another TCB for the second and subsequent subframes 212 in the series of subframes 212, instead of searching for TCBs in the subframe information table 1002 for the second and subsequent subframes 212. Consequently, the number of times of search for the TCBs can be smaller than the number of received subframes 212, so that the load of the protocol processing can be reduced, and thus, the processing efficiency can be increased.

The rearrangement unit 106b rearranges the subframes 212 so that the subframes 212 having the same type of segment data 225 are arranged contiguously. However, the embodiments are not limited to this method. The subframes 212 need not necessarily be rearranged so that the subframes 212 having the same type of segment data 225 are arranged contiguously. That is, after the rearrangement unit 106b has determined whether at least two or more subframes 212 are subframes 212 having the same type of segment data 225, the information addition unit 106c can add the identification information for distinguishing a series of subframes 212 from other series of subframes 212 to each of the subframes 212, so that the protocol processing unit 105 can perform the identification processing of the TCP connection in the protocol processing described above. However, once the rearrangement unit 106b rearranges the subframes 212 so that the series of subframes 212 are arranged contiguously, the communication terminal 10a need not buffer information (such as flags indicating whether TCBs corresponding to the subframes 212 to be processed have already been found) required when the subframes 212 are not rearranged, or need not re-search for TCBs when the buffering is not performed, which is an advantage. In the case where the subframes 212 are not rearranged so that the series of subframes 212 are arranged contiguously, when the protocol processing unit 105 processes each of the subframes 212, the protocol processing unit 105 can use a TCB that has been used for processing a subframe 212 immediately preceding the current subframe 212 for processing the current subframe 212 without changing it to another TCP only when the current subframe 212 and the immediately preceding subframe 212 are included in the same series of subframes 212. Even in this case, the rearrangement provides the advantage of reducing the number of times of search for the TCBs to be smaller than in the case of not performing the rearrangement.

The programs to be executed by each of the communication terminals of the embodiments described above may be provided, for example, by being incorporated in a ROM or the like in advance.

The programs to be executed by the communication terminals of the embodiments described above may be recorded as files in an installable format or an executable format on a computer-readable recording medium, such as a compact disc read-only memory (CD-ROM), a flexible disk (ED), a compact disc recordable (CD-R), or a digital versatile disc (DVD), and provided as a computer program product.

The programs to be executed by the communication terminals of the embodiments described above may be stored on a computer connected to a network, such as the Internet, and provided by being downloaded through the network. The programs to be executed by the communication terminals of the embodiments described above may be provided or distributed through a network, such as the Internet.

The programs to be executed by the communication terminals of the embodiments described above can cause a computer to function as the functional units of the node described above. On this computer, a CPU can read the programs from the computer-readable recording medium into a main memory to execute the programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a receiving unit configured to receive an aggregated frame in which a plurality of subframes are aggregated;
an extraction unit configured to extract each of the subframes from the aggregated frame received by the receiving unit;
an integration unit configured to integrate, among the subframes extracted by the extraction unit, subframes corresponding to the same Transmission Control Protocol (TCP) connection; and
a processing unit configured to perform protocol processing on the subframes integrated by the integration unit.

2. The device according claim 1, wherein the integration unit is configured to integrate two or more of the subframes when it is determined, based on information in subframe headers of the two or more subframes, that each of the two or more subframes includes a TCP segment and has the same source IP address, the same destination IP address, the same source port, and the same destination port, and that sequence numbers of the two or more subframes are consecutive.

3. The device according to claim 1, wherein
the integration unit comprises:
a determination unit configured to determine whether two or more of the subframes among the subframes extracted by the extraction unit are subframes having connectable segment data, based on whether the two or more subframes correspond to the same TCP connection, and whether sequence numbers of the two or more subframes are consecutive; and
a connection unit configured to connect the two or more subframes if the two or more subframes are determined to have the connectable segment data, and
the processing unit is configured to perform the protocol processing on the subframes connected by the connection unit.

4. The device according to claim 3, further comprising a storage unit configured to store the subframes determined to have the connectable segment data, wherein
the connection unit is configured to create list information indicating addresses and lengths of the segment data to be connected stored in the storage unit, and
the processing unit is configured to perform the protocol processing on the segment data to be connected read out from the storage unit according to the list information.

5. The device according to claim 1, wherein
the integration unit comprises an information addition unit configured to integrate the subframes by adding identification information identifying the subframes corresponding to the same TCP connection, and
the processing unit is configured to perform the protocol processing on the subframes integrated by the integration unit with reference to the identification information added by the information addition unit.

6. The device according to claim 5, wherein the integration unit further comprises a rearrangement unit configured to rearrange the subframes extracted by the extraction unit so that the subframes corresponding to the same TCP connection are arranged contiguously.

7. The device according to claim 6, further comprising a storage unit configured to store therein the subframes extracted by the extraction unit, wherein
the rearrangement unit is configured to create list information indicating addresses and lengths of the subframes stored in the storage unit, and to rearrange the list information corresponding to the subframes corresponding to the same TCP connection, and
the processing unit is configured to perform the protocol processing on the subframes read out from the storage unit according to the list information.

8. A communication method comprising:
receiving an aggregated frame in which a plurality of subframes are aggregated;
extracting each of the subframes from the received aggregated frame;
integrating, among the extracted subframes, subframes corresponding to the same Transmission Control Protocol (TCP) connection; and
performing protocol processing on the integrated subframes.

9. A computer program product comprising a computer readable medium including programmed instructions, wherein the instructions, when executed by a computer, cause the computer to function as:
an extraction unit configured to extract each of subframes from an aggregated frame received by a receiving unit configured to receive the aggregated frame in which a plurality of subframes are aggregated;
an integration unit configured to integrate, among the subframes extracted by the extraction unit, subframes corresponding to the same Transmission Control Protocol (TCP) connection; and
a processing unit configured to perform protocol processing on the subframes integrated by the integration unit.
